(19) United States
(12) Patent Application Publication
(10) Pub. No.: US 2026/0083136 A1
(43) Pub. Date: Mar. 26, 2026

(54) METHOD FOR GREEN CONTROL OF CORN PESTS IN INTENSIVE FARMLAND

(71) Applicant: Agro-Environmental Protection Institute, MARA, Tianjin (CN)

(72) Inventors: Yanjun ZHANG, Tianjin (CN); Dianlin YANG, Tianjin (CN); Hui WANG, Tianjin (CN); Guilong ZHANG, Tianjin (CN); Yan XU, Tianjin (CN); Jianning ZHAO, Tianjin (CN)

(21) Appl. No.: 18/983,680

(22) Filed: Dec. 17, 2024

(30) Foreign Application Priority Data
Sep. 25, 2024 (CN) 202411345970.5

(51) Int. Cl. A01N 65/22; A01N 37/28; A01N 43/36; A01N 43/56; A01N 43/90; A01N 57/16; A01N 65/12; A01N 65/20; A01N 65/30; A01P 7/04

(52) U.S. Cl. CPC A01N 65/22; A01N 37/28; A01N 43/36; A01N 43/56; A01N 43/90; A01N 57/16; A01N 65/12; A01N 65/20; A01N 65/30; A01P 7/04

(57) ABSTRACT

A method for green control of corn pests in an intensive farmland is provided, belonging to the technical field of green control. The method for green control of corn pests in an intensive farmland is based on a scheme that combines at least halved application of a high-efficiency and low-toxic insecticide with control by an artificial flower and grass strip. The method can generate a synergistic effect, reduce the use of insecticides, increase a sensitivity of corn borers to natural enemies, protect a natural enemy population, and coordinately control corn borer damages, thereby achieving biodiversity protection and green crop production.

### CROSS REFERENCE TO RELATED APPLICATION

This patent application claims the benefit and priority of Chinese Patent Application No. 2024113459705, filed with the China National Intellectual Property Administration on Sep. 25, 2024, the disclosure of which is incorporated by reference herein in its entirety as part of the present application.

### TECHNICAL FIELD

The present disclosure belongs to the technical field of green pest control, and specifically relates to a method for green control of corn pests in an intensive farmland.

### BACKGROUND

Corn borers are extremely harmful to corn. The damage rate of spring corn is about 30%, resulting in a 10% reduction in yield, while the damage rate of summer corn can reach 90%, generally resulting in a 20% to 30% reduction in yield. Intensification is the mainstream direction of agriculture, but large-scale planting has also led to problems such as reduced agricultural biodiversity and imbalanced ecological functions. Intensive corn cultivation shows extremely serious damage from the corn borers, with yield reductions generally ranging from 15% to 30%. There is also fungal toxin contamination induced, causing production bottlenecks in both yield and quality.

Corn pests are currently mostly controlled by chemical insecticides. However, the dosage of chemical insecticides is increasing due to pest resistance, causing a serious impact on the environment and a toxic effect on natural enemies. Therefore, it is necessary to explore green control methods.

### SUMMARY

The present disclosure provides a method for green control of corn pests in an intensive farmland. The method can increase a sensitivity of corn pests to natural enemies, protect natural enemy populations, coordinate control, and reduce the use of insecticides, thereby achieving biodiversity protection and green production of crops.

The present disclosure provides a method for green control of corn pests in an intensive farmland. The method is based on a scheme combining at least halved application of a high-efficiency and low-toxic insecticide and the control of an artificial flower and grass strip. On one hand, a high-efficiency and low-toxic corn borer insecticide is selected, and half of its dosage or less is applied to produce sublethal toxicity to the corn pests, thereby making them more sensitive to natural enemies. Moreover, the reduction in insecticides reduces the damage to natural enemy parasitic wasps. On the other hand, an artificial flower and grass strip having a combination of nectariferous plants is constructed at the edge of a corn field. The nectariferous plants in the flower and grass strip can provide nectar, pollen, and alternative prey for the natural enemies, prolong the life of parasitic wasps, and increase a reproductive capacity of the natural enemies. Moreover, the nutrients in the pollen can increase a detoxification ability of natural enemies to the insecticides. The method can generate a synergistic effect, reduce the use of insecticides, increase a sensitivity of corn borers to natural enemies, protect a natural enemy population, coordinately control corn borer damages, and reduce grain pesticide and mycotoxin contaminations, thereby achieving biodiversity protection and green crop production.

### BRIEF DESCRIPTION OF THE DRAWINGS

In the drawings wherein like reference numerals denote similar components throughout the views:

FIG. 1 is a flow diagram of the method for green control of corn pests in an intensive farmland, in accordance with an embodiment.

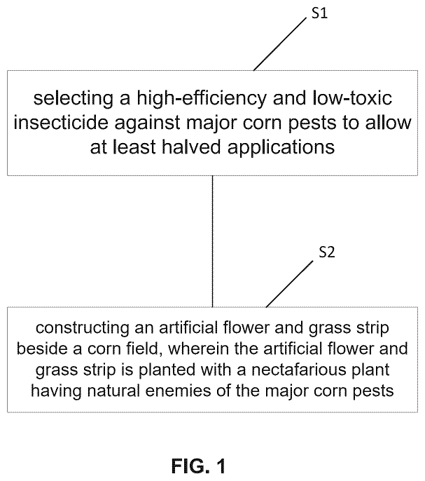

### DETAILED DESCRIPTION OF THE EMBODIMENTS

The present disclosure provides a method for green control of corn pests in an intensive farmland, including the following steps:
(S1) selecting a high-efficiency and low-toxic insecticide against major corn pests to allow at least halved application; and
(S2) constructing an artificial flower and grass strip beside a corn field, where the artificial flower and grass strip is planted with a nectariferous plant having natural enemies of the major corn pests.

The order of step (S1) and step (S2) can be interchanged.

In the present disclosure, the major corn pests include lepidopteran pests, such as corn borer. The high-efficiency and low-toxic insecticides are selected from commercially available corn borer insecticides for use in the method described in the present disclosure; specifically, corn borers are screened by indoor toxicity assay, and an assay standard may be “Guideline for laboratory bioassay of pesticides Part 10: Diet incorporation method” (NY/T1154.10-2008). In addition to screening for killing effects on corn borers, it is also necessary to screen for natural enemies of corn borers, trichogrammatids, such that insecticides with lower indoor toxicity to trichogrammatids can be applied to the present disclosure.

In the present disclosure, the insecticide used for screening includes at least one of the following: emamectin benzoate, chlorantraniliprole, tetrachlorantraniliprole, azadirachtin, chlorfenapyr, methoxyfenozide, and phoxim. After comprehensive screening, the high-efficiency and low-toxic insecticide is chlorantraniliprole, which has an indoor toxicity LC₅₀ (95% CL) value of 0.50 mg/L for corn borer larvae and an indoor toxicity LC₅₀ (95% CL) value of 177.9 mg/L for Trichogramma ostriniae.

In the present disclosure, the high-efficiency and low-toxic insecticide selected is chlorantraniliprole. When corn borer holes are first seen in the field during the corn flared period, 10 mL of 200 g/L chlorantraniliprole suspension per mu is diluted with 50 L of water and then sprayed evenly, while the heart leaves are irrigated 1 time.

In the present disclosure, the artificial flower and grass strip in step (2) is constructed at an edge of the corn field and has a width of 2 m to 4 m. In an example, when the field is square in shape, the plant buffer is constructed along a long side of the field; if the field is irregular in shape, the plant buffer is constructed along a perimeter of the field. Before planting, the artificial flower and grass strip is preferably treated with compound fertilizer as a base fertilizer, and perennial nectariferous plants are sown in the autumn of a first year; and annual nectariferous plants are sown in the spring of a second year. In an example, 40 kg of compound fertilizer (N:P:K=15:15:15) is applied per mu as a base fertilizer before planting; during the sowing in the autumn of the first year, perennial plant mixed seeds are sown with a hand-cranked seeder at a sowing weight of 5 g per square meter. After sowing, the seeds are covered with 1 cm of soil and then compacted with a compactor. When sowing in the spring of the second year, the annual plant mixed seeds are sown in rows at a sowing weight of 2 g per square meter. It is ensured that the soil is fully moist within 3 to 4 weeks after sowing, and malignant weeds (such as humulus and reeds) are removed manually or mechanically as soon as they can be identified.

In the present disclosure, the nectariferous plant is at least one selected from the group consisting of Agastache rugosa, Mentha haplocalyx, Medicago sativa, Sesamum indicum, Helianthus annuus, Fagopyrum esculentum, Centaurea cyanus, Petunia hybrida, Cosmos bipinnatus, spring rapeseed, Potentilla chinensis, Cirsium arvense var. integrifolium Wimm. & Grab., Ixeris polycephala, Vicia faba, Hemisteptia lyrata, and Lagopsis supina, preferably Centaurea cyanus, Fagopyrum esculentum, Helianthus annuus, Sesamum indicum, Vicia faba, and Medicago sativa.

In the present disclosure, the highly effective pesticides selected in the integrated prevention and control of corn fields produce sublethal effects on corn borers, while the reduction of pesticide dosage reduces the toxicity to natural enemies; the combination of the preferred nectariferous plants in the artificial flower and grass strip protects the natural enemy population and can enhance the biological control effect on corn; an ecological regulation effect of the chemical pesticides and flower and grass strip together achieves a synergistic effect.

In order to further illustrate the present disclosure, the method for green control of corn pests in an intensive farmland provided by the present disclosure is described in detail below in connection with examples, but these examples should not be understood as limiting the claimed scope of the present disclosure.

### Example 1

### 1. Screening of High-Efficiency and Low-Toxic Insecticide for Corn Borers

### 1.1 Screening Process

### 1.1.1 Screening Process of Corn Borer Insecticides

The tested corn borers were reared indoors in an insect-raising room at (27±1° C.), a relative humidity of 50% to 75%, and a photoperiod of L/D=14 h/10 h, and 3-instar larvae of the same age were selected for inoculation.

Test agents: the indoor test used 95.3% chlorantraniliprole technical, 95% tetrachlorantraniliprole technical, 96% emamectin benzoate technical, 98% chlorfenapyr technical, 98% methoxyfenozide technical, 87% phoxim technical, and 10% azadirachtin extract.

The field tests used the corresponding 200 g/L chlorantraniliprole suspension, 10% tetrachlorantraniliprole suspension, 5% emamectin benzoate soluble granules, 10% chlorfenapyr suspension, 24% methoxyfenozide suspension (Shandong Sino-Agri Union Co., Ltd.), 40% phoxim emulsifiable concentrate (EC), and 0.3% azadirachtin EC.

Indoor toxicity test on corn borer: according to the “Guideline for laboratory bioassay of pesticides Part 10: Diet incorporation method” (NY/T1154.10-2008).

The field control effect of corn borer was evaluated during the corn flared period, when corn borer damage holes began to appear in the field, the pesticide was sprayed evenly and the heart leaves were irrigated. The experiment set up 15 treatments, diluted to 50 L/mu with water for application:
Treatment 1 and 2: 200 g/L chlorantraniliprole suspension 150 and 225 mL/hm²;
Treatment 3 and 4: 10% tetrachlorantraniliprole suspension 300 and 450 mL/hm²;
Treatments 5 and 6: 5% emamectin benzoate soluble granules 195 and 390 g/hm²;
Treatments 7 and 8: 10% chlorfenapyr suspension 500 and 1,000 mL/hm²;
Treatments 9 and 10: 240 g/L methoxyfenozide suspension 300 and 450 mL/hm²;
Treatments 11 and 12: 40% phoxim EC 1,125 and 1,500 mL/hm²;
Treatments 13 and 14: 0.3% azadirachtin EC 2.7 and 4.5 g/hm²;
Treatment 15: a control group with clear water.

Each treatment was repeated 3 times, the plot area was 100 m², and the plots were arranged in random blocks. The row spacing of corn was 0.6 m and the plant spacing was 26 cm. The survey was conducted 30 d after the application of the pesticide. Samples were taken at 5 points in each plot, and 50 corn plants were surveyed at each point. The number of corn affected plants, the number of borer holes, and the number of insect populations after dissecting the stalks were investigated to calculate the corresponding control effect.

$$Wormhole reduction rate = ( number of control wormholes - number of treated wormholes ) / number of control wormholes \times 100 \% .$$

$$damaged plant reduction rate = ( number of damaged plants in control group - number of damaged plants in treatment group ) / number of damaged plants in control group \times 100 \% ;$$

$$pest population reduction rate = ( pest population in control group - pest population in treatment group ) / pest population in control group \times 100 \% ;$$

$$control effect 30 d after application of pesticide = ( wormhole reduction rate + damaged plant reduction rate + overall pest population reduction rate ) / 3.$$

The toxicity regression equation, LC₅₀, and 950 confidence interval were calculated using the Probit probability value analysis method.

The results were shown in Table 1. The most toxic one was emamectin benzoate, with an LC₅₀ value of 0.28 mg/L; the next ones were chlorantraniliprole, tetrachlorantraniliprole, azadirachtin, chlorfenapyr, and methoxyfenozide; phoxim has the lowest toxicity, with an LC₅₀ value of 128.6 mg/L.

TABLE 1
Indoor toxicity of 7 insecticides to corn borer larvae

| | Slope ± standard | LC₅₀ (95% CL) | |
|---|---|---|---|
| Reagent | error | (mg/L) | |
| Chlorantraniliprole | 0.95 ± 0.14 | 0.50 | (0.25-0.9) |
| Tetrachlorantraniliprole | 0.92 ± 0.16 | 0.51 | (0.26-1.0) |
| Emamectin benzoate | 1.21 ± 0.15 | 0.28 | (0.1-0.4) |
| Chlorfenapyr | 1.44 ± 0.25 | 8.2 | (5.4-13.4) |
| Methoxyfenozide | 0.96 ± 0.12 | 98.3 | (51.4-210.8) |
| Phoxim | 1.34 ± 0.21 | 128.6 | (80.1-208.5) |
| Azadirachtin | 2.03 ± 0.35 | 6.4 | (4.9-8.4) |

Table 2 showed the control effects of 7 insecticides on corn borer at ear stage 30 d after application. The control effects were ranked as follows: 200 g/L chlorantraniliprole suspension, 10% tetrachlorantraniliprole suspension, 0.30% azadirachtin EC, 500 emamectin benzoate soluble granules, 10% chlorfenapyr suspension, 40% phoxim EC, and 240 g/L methoxyfenozide suspension.

TABLE 2
Control effects of 7 insecticides on corn
borer at ear stage 30 d after application

| | Wormhole | | Damaged plant | | Pest population | | | |
|---|---|---|---|---|---|---|---|---|
| | reduction | | reduction | | reduction | | Efficacy | |
| Treatment | rate (%) | | rate (%) | | rate (%) | | (%) | |
| Treatment 1 | 80.72 | ab | 77.64 | ab | 82.01 | ab | 80.12 | ab |
| Treatment 2 | 83.94 | a | 81.66 | a | 84.96 | a | 83.52 | a |
| Treatment 3 | 80.45 | ab | 76.88 | ab | 81.30 | ab | 79.54 | ab |
| Treatment 4 | 83.84 | a | 80.83 | a | 84.32 | a | 83.00 | a |
| Treatment 5 | 78.14 | ab | 73.30 | ab | 78.44 | bc | 76.62 | bc |
| Treatment 6 | 82.51 | ab | 77.56 | ab | 81.09 | ab | 80.39 | ab |
| Treatment 7 | 75.91 | bc | 69.07 | bc | 74.89 | c | 73.29 | c |
| Treatment 8 | 79.16 | ab | 72.80 | ab | 78.66 | bc | 76.87 | bc |
| Treatment 9 | 40.54 | e | 42.30 | e | 45.25 | f | 42.70 | e |
| Treatment 10 | 45.92 | c | 47.98 | e | 49.82 | f | 47.91 | c |
| Treatment 11 | 63.68 | d | 57.71 | d | 60.69 | e | 60.69 | d |
| Treatment 12 | 69.58 | cd | 60.79 | cd | 67.07 | d | 65.81 | d |
| Treatment 13 | 79.6 | ab | 71.2 | ab | 78.4 | bc | 79.2 | ab |
| Treatment 14 | 81.2 | ab | 75.6 | ab | 80.6 | ab | 81.0 | ab |

### 1.1.2 Screening Process of Reagent for Trichogrammatids

Test agents: the same as those in 1.1.

Test natural enemy: Trichogramma ostriniae

The toxicity of Trichogramma ostriniae to corn borer was determined by the tube film method. After preparing drug solutions with different concentration gradients, 1 μL of Tween-20 was added to each solution and shaken thoroughly. 2 mL of the configured concentration drug solution was pipetted into a 50 mL finger-shaped tube, and the control group was added with an equal amount of distilled water, the finger-shaped tube was quickly rotated to evenly coat the inner wall of the tube with the drug solution. Finally, the excess drug solution was discarded, the finger-shaped tube was inverted on filter paper, and air-dried indoors to form a drug film tube. Trichogramma ostriniae was propagated by eggs of the Corcyra cephalonica, 5 Corcyra cephalonica eggs were placed in each drug film tube. After 2 h, the Corcyra cephalonica egg shells were quickly removed and the Trichogramma dendrolimi was kept. The tube was placed in a light incubator at 25° C., a humidity of (75±1)%, and a photoperiod of D:L=16 h:8 h. After 24 h, the number of trichogrammatids and the number of deaths (the trichogrammatids were considered dead if they did not crawl) were checked, and the mortality rate was calculated.

The indoor toxicity of the 7 insecticides to Trichogramma ostriniae was shown in Table 3, and the ranking was as follows: emamectin benzoate, phoxim, chlorfenapyr, methoxyfenozide, tetrachlorantraniliprole, chlorantraniliprole, and azadirachtin.

TABLE 3
Indoor toxicity of 7 insecticides to Trichogramma ostriniae

| | Slope ± standard | LC₅₀ (95% CL) |
|---|---|---|
| Reagent | error | (mg/L) |
| Chlorantraniliprole | 1.47 ± 0.21 | 177.9 (96.8-264.2) |
| Tetrachlorantraniliprole | 1.45 ± 0.15 | 171.4 (92.3-254.1) |
| Emamectin benzoate | 2.44 ± 0.18 | 28.1 (20.5-34.8) |
| Chlorfenapyr | 1.12 ± 0.11 | 78.6 (60.2-95.8) |
| Methoxyfenozide | 1.41 ± 0.19 | 161.5 (82.8-244.1) |
| Phoxim | 2.11 ± 0.15 | 35.2 (26.7-42.1) |
| Azadirachtin | 1.55 ± 0.28 | 185.6 (99.1-260.1) |

### 2. Selection of Flower and Grass Combinations and Construction of Artificial Flower and Grass Strip

Nectariferous plant varieties were selected based on the extended lifespan of parasitic wasps, increased reproductive capacity, and the detoxification ability of natural enemies to pesticides as indicators, a comprehensive evaluation was conducted to select a combination of flowers and plants with excellent effects. A 3-meter-wide artificial flower and grass strip was planted on the edge of a corn field using a combination of flower and grass plants.

### 2.1 Nectariferous Plant

The nectariferous plant was selected from the group consisting of Agastache rugosa, Mentha haplocalyx, Medicago sativa, Sesamum indicum, Helianthus annuus, Fagopyrum esculentum, Centaurea cyanus, Petunia hybrida, Cosmos bipinnatus, spring rapeseed, Potentilla chinensis, Cirsium arvense var. integrifolium Wimm. & Grab., Ixeris polycephala, Vicia faba, Hemisteptia lyrata, and Lagopsis supina. The experimental flowers were conventionally cultivated in a glass greenhouse and used in the experiment after flowering.

2.2 Beneficial Effects of Nectar/Pollen Feeding on Trichogramma ostriniae
2.2.1 Lifespan and Parasitism of Trichogramma ostriniae after Feeding on Nectar/Pollen

The fresh flowers of nectariferous plants were collected, the flower stalks were moistened with wet cotton balls, and then each flower was put into a glass tube (5 cm long and 2 cm in diameter). At the same time, an inactivated Corcyra cephalonica egg card (having about 150 eggs) was also placed in the tube, and a newly emerged (<3 h) female adult of Trichogramma ostriniae that had undergone group mating was inoculated. The blank control did not contain flowers but used wet cotton balls instead, with other conditions being the same. The survival of Trichogramma ostriniae was observed 1 time every 2 h. Fresh blooming flowers were replaced daily and the egg cards placed 1 day before were replaced with fresh ones. After the Corcyra cephalonica eggs turned black, the number of black Corcyra cephalonica eggs (parasitized) was recorded. The experiment was conducted in a climate incubator at (28±1°) C, a relative humidity of 70% to 80%, and a photoperiod of 14 h:10 h (LID), each treatment was repeated 20 times.

The results were shown in Table 4. After female Trichogramma ostriniae was feed on plant nectar/pollen, the effect of extending and improving lifespan and parasitic ability was ranked as follows: Centaurea cyanus>Heianthus annuus>Sesamum indicum>Fagopyrum esculentum>Vicia faba>Cirsium arvense var. integrifolium Wimm. & Grab.>Hemisteptia lyrata>Medicago sativa>spring rapeseed>Ixeris polycephala>Agastache rugosa>Mentha haplocalyx>Potentilla chinensis>Lagopsis supina>Cosmos bipinnatus>Petunia hybrida.

TABLE 4
Differences in lifespan and parasitism of female adults
of Trichogramma ostriniae feeding on different flowers

| | | Parasitic |
|---|---|---|
| Treatment | Lifespan (h) | ability |
| Clean water | 28.4 ± 1.62 d | 28.8 ± 2.54 d |
| Agastache rugosa | 64.3 ± 11.2 b | 60.1 ± 7.9 bc |
| Mentha haplocalyx | 58.9 ± 5.9 bc | 52.3 ± 8.5 c |
| Medicago sativa | 87.2 ± 15.3 ab | 82.5 ± 10.2 ab |
| Sesamum indicum | 96.7 ± 12.8 a | 90.1 ± 15.2 a |
| Helianthus annuus | 98.6 ± 11.9 a | 90.9 ± 18.6 a |
| Fagopyrum esculentum | 95.8 ± 14.6 a | 92.5 ± 15.4 a |
| Centaurea cyanus | 102.5 ± 11.7 a | 95.2 ± 11.4 a |
| Petunia hybrida | 42.1 ± 5.8 c | 45.6 ± 7.2 c |
| Cosmos bipinnatus | 48.6 ± 3.6 c | 44.1 ± 8.2 c |
| Spring rapeseed | 84.6 ± 15.3 ab | 80.6 ± 10.8 b |
| Potentilla chinensis | 58.3 ± 9.4 bc | 65.1 ± 9.2 bc |
| Cirsium arvense var. integrifolium | 89.7 ± 10.2 ab | 90.2 ± 14.4 a |
| Wimm. & Grab. | | |
| Ixeris polycephala | 72.3 ± 8.4 b | 71.0 ± 10.7 b |
| Vicia faba | 91.2 ± 9.2 ab | 88.6 ± 12.8 ab |
| Hemisteptia lyrata | 88.6 ± 15.2 ab | 85.2 ± 14.1 ab |
| Lagopsis supina | 57.3 ± 6.1 bc | 50.3 ± 7.5 c |

2.3 Pesticide Resistance and Detoxification Ability of Trichogrammatids ostriniae after Feeding on Nectar/Pollen

After the adult Trichogramma ostriniae was fed with nectar from different plants, the LC₅₀ value of chlorantraniliprole against Trichogramma ostriniae was determined by the tube test film method to reflect the changes in the resistance of Trichogramma ostriniae to pesticides.

Chlorantraniliprole was diluted with acetone to a sublethal concentration (177.9 mg/mL). After drawing 0.5 mL of chlorantraniliprole by pipette and slowly adding into the finger-shaped tube (inner wall area: 54.6 cm²) along the tube wall, the finger-shaped tube was rotated at a constant speed such that chlorantraniliprole was evenly distributed on the inner wall of the finger-shaped tube to form a drug film. After the drug solution has completely evaporated, 200 adult Trichogramma ostriniae fed with nectar from different plants were introduced into each finger-shaped tube. The tube mouth was sealed with black cloth and the tube was placed in an artificial climate box (25±1° C., relative humidity 75%±5%, photoperiod 15 L: 9 D) for 8 h, and 100 surviving adults were collected. After quick freezing with liquid nitrogen, the samples were stored in a −80° C. refrigerator for later use. The samples to be tested were placed in a homogenizer, added with 1.2 mL of pre-cooled 0.1 mol/L PBS (pH=7.4) and the samples were homogenized thoroughly using a homogenizer. After the homogenate was centrifuged at 4° C. and 10,000 g for 10 min, a supernatant was transferred to a new centrifuge tube and placed on ice as enzyme solution for later use. ELISA was conducted to measure the activity of glutathione S-transferase to reflect the changes in the detoxification ability of Trichogramma ostriniae to pesticides.

Table 5 showed that after Trichogramma ostriniae feeding on plant nectar/pollen, the LC₅₀ values of chlorantraniliprole against Trichogramma ostriniae were ranked as follows: Centaurea cyanus>Fagopyrum esculentum>Helianthus annuus>Sesamum indicum>Vicia faba>Medicago sativa>Cirsium arvense var. integrifolium Wimm. & Grab.>Hemisteptia lyrata>spring rapeseed>Ixeris polycephala>Agastache rugosa>Mentha haplocalyx>Lagopsis supina>Potentilla chinensis>Petunia hybrida>Cosmos bipinnatus. The detoxification ability was ranked as follows: Centaurea cyanus>Fagopyrum esculentum>Helianthus annuus>Sesamum indicum>Vicia faba>Medicago sativa>Cirsium arvense var. integrifolium Wimm. & Grab.>Hemisteptia lyrata>spring rapeseed>Ixeris polycephala>Agastache rugosa>Mentha haplocalyx>Lagopsis supina>Potentilla chinensis>Petunia hybrida>Cosmos bipinnatus.

TABLE 5
Drug resistance and detoxification ability of Trichogramma ostriniae
adults feeding on different flowers

| | | Glutathione S- |
|---|---|---|
| | | transferase activity |
| | LC₅₀ (95% CL) | (95% CL) (mmol/ |
| Treatment | (mg/L) | min/mg protein) |
| Clean water | 177.9 (96.8-264.2) c | 1.88 (1.75-1.91) c |
| Agastache rugosa | 226.2 (205.4-230.2) bc | 2.24 (2.08-2.40) bc |
| Mentha haplocalyx | 216.2 (204.1-228.8) bc | 2.23 (2.01-2.38) bc |
| Medicago sativa | 252.0 (230.3-274.2) b | 2.37 (2.30-2.51) b |
| Sesamum indicum | 270.1 (250.8-305.2) ab | 2.50 (2.31-2.66) ab |
| Helianthus annuus | 272.1 (251.8-304.2) ab | 2.51 (2.32-2.67) ab |
| Fagopyrum esculentum | 281.1 (262.8-314.5) a | 2.55 (2.40-2.77) a |
| Centaurea cyanus | 285.3 (266.8-324.5) a | 2.61 (2.42-2.83) a |
| Petunia hybrida | 188.3 (176.1-195.2) c | 1.98 (1.84-2.01) c |
| Cosmos bipinnatus | 181.2 (171.1-190.3) c | 1.91 (1.81-1.99) c |
| Spring rapeseed | 228.0 (208.4-232.2) bc | 2.28 (2.11-2.48) bc |
| Potentilla chinensis | 191.3 (181.1-201.7) c | 2.03 (1.94-2.08) c |
| Cirsium arvense var. | 250.0 (230.1-272.2) b | 2.35 (2.28-2.55) b |
| integrifolium Wimm. & | | |
| Grab. | | |
| Ixeris polycephala | 227.2 (207.4-231.2) bc | 2.27 (2.10-2.42) bc |
| Vicia faba | 252.1 (230.1-275.2) b | 2.38 (2.31-2.46) b |
| Hemisteptia lyrata | 248.0 (228.1-262.2) b | 2.31 (2.21-2.49) b |
| Lagopsis supina | 200.2 (184.1-208.8) c | 2.13 (2.01-2.18) c |

### 2.4 Optimization of Flower and Grass Combinations and Construction of Artificial Flower and Grass Strip

The optimized flower and grass combination was: Centaurea cyanus, Fagopyrum esculentum, Helianthus annuus, Sesamum indicum, Vicia faba, and Medicago sativa. The width of the plant buffer zone during land preparation at the edge of the farmland was 2 m to 4 m. If the field was square, the plant buffer zone was constructed along a long side of the field; if the field was irregular, the plant buffer zone was constructed along a perimeter of the field. Before planting, 40 kg of compound fertilizer (N:P:K=15:15:15) was applied per mu as a base fertilizer. When sowing in the autumn of the first year, the perennial plants Centaurea cyanus and Medicago sativa were mixed in equal proportions by mass and the grass seeds were sown using a hand-crank seeder, where grass seeds was 5 g per square meter, and the soil was covered by 1 cm and compacted with a roller after sowing. When sowing in the spring of the second year, the annual plants Fagopyrum esculentum, Helianthus annuus, Sesamum indicum, and Vicia faba were sown in equal proportions in rows at a sowing weight of 2 g per square meter. It was ensured that the soil was fully moist within 3 to 4 weeks after sowing, and malignant weeds (such as humulus and reeds) were removed manually or mechanically as soon as they could be identified.

3. The Reduction of Chemical Insecticides Combined with the Construction of Artificial Flower and Grass Strip Generated a Synergistic Effect.

The test was completed in Zhouzhuang Village, Meichang Town, Wuqing District, Tianjin (117.219896 east longitude, 39.364681 north latitude). The tested corn variety was ‘Xianyu 335’, and the row spacing of corn was 0.6 m and the plant spacing was 26 cm. The experimental field was 200 m long and 100 m wide. A 3-meter-wide artificial flower and grass strip was planted on one long edge in the autumn of 2021, a flower and grass combination was Centaurea cyanus, Fagopyrum esculentum, Helianthus annuus, Sesamum indicum, Vicia faba, and Medicago sativa. When sowing in the autumn of the first year, the perennial plants Centaurea cyanus and Medicago sativa were mixed in equal proportions by mass and the grass seeds were sown using a hand-crank seeder, where grass seeds was 5 g per square meter. When sowing in the spring of the second year, the annual plants Fagopyrum esculentum, Helianthus annuus, Sesamum indicum, and Vicia faba were sown in equal proportions in rows at a sowing weight of 2 g per square meter. The other long edge was planted with crops normally and served as a control with no flowers or grass.

The recommended field dosage of 200 g/L chlorantraniliprole suspension, a highly effective pesticide for corn borer, was 10 mL/mu. If being diluted with 50 L of water, the recommended concentration was 40 mg/L. There were 5 gradient dosages, namely 0.004, 0.04, 0.4, 4, and 40 mg/L, and a blank control of clean water, for a total of 6 treatments. Each treatment was replicated 3 times, and each replicate plot was 10 m*10 m with a spacing of 1 m between plots. Artificial spraying was done during the peak hatching period of corn borer eggs, and the spraying time was Aug. 1, 2023.

The survey was conducted 30 d after the application of the pesticide. Samples were taken at 5 points in each plot, and 50 corn plants were surveyed at each point. The number of corn affected plants, the number of borer holes, and the number of insect populations after dissecting the stalks were investigated to calculate the corresponding protective effect and LC₅₀ value of chlorantraniliprole on corn borer.

Referring to the pesticide co-toxicity coefficient method, the synergistic coefficient (CIC value) of the combined measures was calculated according to the following formula:

The composite measure (CM) included chlorantraniliprole measure A1 and flower and grass strip measure A2. Each measure had its own control effect value against corn borer. The improvement index of measure A1 was set as a standard value of 100.

A2 improvement index=A2 control effect value/A1 control effect value×100;

CM actual improvement index=CM control effect value/A1 control effect value×100;

CM theoretical improvement index=A1 improvement index+A2 improvement index;

CIC value=CM actual improvement index/CM theoretical improvement index×100;

CIC≥120 indicated a synergistic effect;CIC≤80 indicated an antagonistic effect;80<CIC<120 indicated an additive effect.

The results were shown in Table 6. The CIC values of “flower and grass strip+chlorantraniliprole 0.4 mg/L” and “flower and grass strip+chlorantraniliprole 4 mg/L” were both greater than 120, and these two combined measures showed a synergistic effect. The control effect of “flower and grass strip+4 mg/L chlorantraniliprole” against corn borer reached 100%, the dosage of chlorantraniliprole used in the combined measure was only 1/10 of that of single chemical control, which was safer for the ecological environment of farmland.

TABLE 6
Influence of using chlorantraniliprole and artificial flower and grass strip

| | | | | | CM | |
|---|---|---|---|---|---|---|
| | | A1 | A2 | CM actual | theoretical | |
| | Efficacy | improvement | improvement | improvement | improvement | CIC |
| Treatment | (%) | index | index | index | index | value |
| No flower and | — | — | — | — | — | — |
| grass strip + pure | | | | | | |
| water | | | | | | |
| No flower and | 1.6 | — | — | — | — | — |
| grass strip + | | | | | | |
| chlorantraniliprole | | | | | | |
| 0.004 mg/L | | | | | | |
| No flower and | 10.1 | — | — | — | — | — |
| grass strip + | | | | | | |
| chlorantraniliprole | | | | | | |
| 0.04 mg/L | | | | | | |
| No flower and | 20.2 | — | — | — | — | — |
| grass strip + | | | | | | |
| chlorantraniliprole | | | | | | |
| 0.4 mg/L | | | | | | |
| No flower and | 50.2 | — | — | — | — | — |
| grass strip + | | | | | | |
| chlorantraniliprole | | | | | | |
| 4 mg/L | | | | | | |
| No flower and | 95.1 | — | — | — | — | — |
| grass strip + | | | | | | |
| chlorantraniliprole | | | | | | |
| 40 mg/L | | | | | | |
| Flower and grass | 30.5 | — | — | — | — | — |
| strip + pure water | | | | | | |
| Flower and grass | 35.3 | 100 | 1906.3 | 2206.3 | 2006.3 | 110.0 |
| strip + | | | | | | |
| chlorantraniliprole | | | | | | |
| 0.004 mg/L | | | | | | |
| Flower and grass | 45.2 | 100 | 302.0 | 447.5 | 402.0 | 111.3 |
| strip + | | | | | | |
| chlorantraniliprole | | | | | | |
| 0.04 mg/L | | | | | | |
| Flower and grass | 61.5 | 100 | 151.0 | 304.5 | 251.0 | 121.3 |
| strip + | | | | | | |
| chlorantraniliprole | | | | | | |
| 0.4 mg/L | | | | | | |
| Flower and grass | 100 | 100 | 60.8 | 199.2 | 160.8 | 123.9 |
| strip + | | | | | | |
| chlorantraniliprole | | | | | | |
| 4 mg/L | | | | | | |
| Flower and grass | 100 | 100 | 32.1 | 105.2 | 132.1 | 79.6 |
| strip + | | | | | | |
| chlorantraniliprole | | | | | | |
| 40 mg/L | | | | | | |

Although the above example has described the present disclosure in detail, it is only a part of, not all of, the examples of the present disclosure. Other examples may also be obtained by persons based on the example without creative efforts, and all of these examples shall fall within the protection scope of the present disclosure.

1. A method for green control of corn pests in an intensive farmland, comprising:
(S1) selecting a high-efficiency and low-toxic insecticide against major corn pests to allow at least halved application; and
(S2) constructing an artificial flower and grass strip beside a corn field, wherein the artificial flower and grass strip is planted with a nectariferous plant having natural enemies of the major corn pests;
the order of S1 and S2 can be interchanged.

2. The method according to claim 1, wherein the major corn pests comprise lepidopteran pests; and the high-efficiency and low-toxic insecticide is at least one selected from the group consisting of emamectin benzoate, chlorantraniliprole, tetrachlorantraniliprole, azadirachtin, chlorfenapyr, methoxyfenozide, and phoxim.

3. The method according to claim 1, wherein the at least halved application in step (S1) comprises applying the high-efficiency and low-toxic insecticide at an application rate at least halved according to an application rate in instructions of the high-efficiency and low-toxic insecticide.

4. The method according to claim 1, wherein the artificial flower and grass strip in step (S2) is constructed at an edge of the corn field and has a width of 2 m to 4 m.

5. The method according to claim 4, wherein seeds of a perennial nectariferous plant are sown in autumn of a first year and seeds of an annual nectariferous plant are sown in spring of a second year before the artificial flower and grass strip is constructed.

6. The method according to claim 5, wherein the seeds of the perennial nectariferous plant are sown at 5 g/m²; and the seeds of the annual nectariferous plant are sown at 2 g/m².

7. The method according to claim 5, wherein the nectariferous plant is at least one selected from the group consisting of Agastache rugosa, Mentha haplocalyx, Medicago sativa, Sesamum indicum, Helianthus annuus, Fagopyrum esculentum, Centaurea cyanus, Petunia hybrida, Cosmos bipinnatus, spring rapeseed, Potentilla chinensis, Cirsium arvense var. integrifolium Wimm. & Grab., Ixeris polycephala, Vicia faba, Hemisteptia lyrata, and Lagopsis supina.

8. The method according to claim 6, wherein the nectariferous plant is at least one selected from the group consisting of Agastache rugosa, Mentha haplocalyx, Medicago sativa, Sesamum indicum, Helianthus annuus, Fagopyrum esculentum, Centaurea cyanus, Petunia hybrida, Cosmos bipinnatus, spring rapeseed, Potentilla chinensis, Cirsium arvense var. integrifolium Wimm. & Grab., Ixeris polycephala, Vicia faba, Hemisteptia lyrata, and Lagopsis supina.
